(19) United States
(12) Patent Application Publication
(10) Pub. No.: US 2026/0257863 A1
(43) Pub. Date: Sep. 3, 2026

(54) SKIRTBOARD LINER ASSEMBLIES

(71) Applicant: Martin Engineering Company, Neponset, IL (US)

(72) Inventors: Marco Antonio MONICA, Paulínia (BR); Anderson Luis Barros SERRA, Paulínia (BR); Leandro Renato de SOUZA, Mogi Guaçu (BR)

(73) Assignee: Martin Engineering Company, Neponset, IL (US)

(21) Appl. No.: 19/539,947

(22) Filed: Feb. 13, 2026

Related U.S. Application Data
(60) Provisional application No. 63/765,195, filed on Feb. 28, 2025.

(51) Int. Cl. B65G 15/30; B65G 15/40; B65G 15/42; B65G 21/20; B65G 47/26

(52) U.S. Cl. CPC B65G 15/30; B65G 15/40; B65G 15/42; B65G 21/2081; B65G 47/261

(57) ABSTRACT

Disclosed herein is a skirtboard liner assembly for a conveyor system including a liner body defining a cavity including a plate slot and a T-slot extending from the plate slot, an inner plate positioned within the plate slot of the cavity formed in the liner body, and a protrusion fixed to an attachment surface of the inner plate and positioned within the T-slot of the cavity formed in the liner body, the protrusion including an upper protrusion portion and a lower protrusion portion.

### CROSS-REFERENCE TO RELATED APPLICATION

This application claims the benefit of co-pending U.S. Provisional Patent Application No. 63/765,195, filed February 28, 2025, for “Skirtboard Liner Assemblies,” which is hereby incorporated by reference in its entirety including the drawings.

### TECHNICAL FIELD

The present specification generally relates to skirtboards for conveyor systems and, more specifically, to skirtboard liner assemblies and methods for easy installation and mobility of a skirtboard liner assembly onto a conveyor system.

### BACKGROUND

Conveyor systems transfer contents along a conveyor belt. The conveyor systems may include liners to guide the contents moving along the conveyor belt and protect a skirtboard of the conveyor system. The liners are attached to other parts of the conveyor system, such as the skirtboard. The installation procedure of liners onto the conveyor system can be complex. Traditionally, liners are fastened via bolts such as by extending a hex head of the bolt into the liner from an inner side of a skirtboard and through the skirtboard, where the bolt is then fastened with a hex nut and a washer on an outer side of the skirtboard.

Accordingly, a need exists for improved liners that accommodate a simplified installation procedure.

### SUMMARY

In one embodiment, a skirtboard liner assembly for a conveyor includes a liner body defining a cavity including a plate slot and a T-slot extending from the plate slot, an inner plate positioned within the plate slot of the cavity formed in the liner body, and a protrusion fixed to an attachment surface of the inner plate and positioned within the T-slot of the cavity formed in the liner body, the protrusion including an upper protrusion portion and a lower protrusion portion.

In another embodiment, a skirtboard liner assembly for a conveyor includes a conveyor surface, a skirtboard provided on opposite sides of the conveyor surface, and a skirtboard liner assembly including a liner body fixed to the skirtboard, the liner body defining a cavity including a plate slot and a T-slot extending from the plate slot, an inner plate positioned within the plate slot of the cavity formed in the liner body, a protrusion fixed to an attachment surface of the inner plate and positioned within the T-slot of the cavity formed in the liner body, the protrusion including an upper protrusion portion and a lower protrusion portion, and one or more fasteners fixed into the skirtboard, the one or more fasteners including a head and a shaft, the head of the fastener positionable within the T-slot of the cavity.

In yet another embodiment, a method includes extending a shaft of a fastener through an opening formed in a skirtboard at an inner surface of the skirtboard, the fastener including a head provided at an end of the shaft, attaching a locknut onto the shaft of the fastener at an outer surface of the skirtboard, sliding a liner body relative to the skirtboard such that the head of the fastener is received within a T-slot of a cavity formed in the liner body, and engaging the locknut with the fastener to secure the liner body to the skirtboard.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional front end view of a conveyor system, according to one or more embodiments shown and described herein;

FIG. 2 schematically depicts a perspective view of a skirtboard liner assembly of the conveyor system, according to one or more embodiments shown and described herein;

FIG. 3 schematically depicts an exploded perspective view of the skirtboard liner assembly, according to one or more embodiments shown and described herein; and

FIG. 4 schematically depicts a cross-sectional side view of the skirtboard liner assembly, according to one or more embodiments shown and described herein.

### DETAILED DESCRIPTION

Embodiments described herein are directed to a skirtboard liner assembly for a conveyor system including a conveyor belt. The skirtboard liner assembly generally includes a liner body, an inner plate, and one or more protrusions. The liner body defines a cavity and the inner plate and the one or more protrusions are provided within the cavity. Various embodiments of the skirtboard liner assembly and the method of using are described in more detail herein. Whenever possible, the same reference numerals will be used throughout the drawings to refer to the same or like parts.

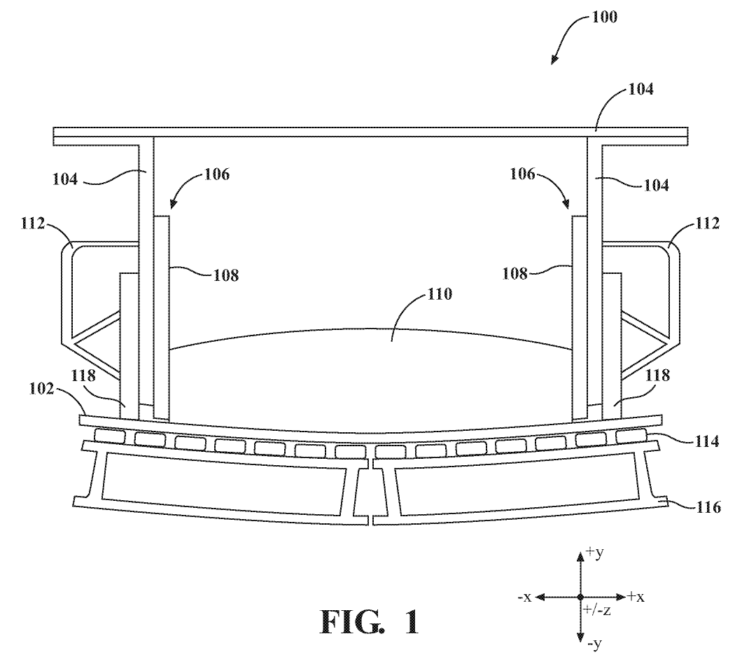

As used herein, the term “conveyor longitudinal direction” refers to the forward-rearward direction of the conveyor belt (i.e., in the +/- Z direction of the coordinate axes depicted in FIG. 1). The term “conveyor lateral direction” refers to the cross-conveyor belt direction (i.e., in the +/- X direction of the coordinate axes depicted in FIG. 1), and is transverse to the conveyor longitudinal direction. The term “conveyor vertical direction” refers to the upward-downward direction of the conveyor belt (i.e., in the +/- Y direction of the coordinate axes depicted in FIG. 1). As used herein, “upper” and “above” are defined as the positive Y direction of the coordinate axes shown in the drawings. “Lower” and “below” are defined as the negative Y direction of the coordinate axes shown in the drawings.

As used herein, the term “conveyor surface” refers to the conveyor belt portion of the conveyor system. This portion of the conveyor system is moving and used to move contents from one location in the conveyor system to another location in the conveyor system.

As used herein, the singular forms “a,” “an” and “the” include plural referents unless the context clearly dictates otherwise. Thus, for example, reference to “a” component includes aspects having two or more such components, unless the context clearly indicates otherwise.

Directional terms as used herein - for example up, down, right, left, front, back, top, bottom - are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

Referring now to FIG. 1, a conveyor system 100 is illustrated according to one or more embodiments described herein. The conveyor system 100 includes a conveyor surface 102 for moving contents 110, a skirtboard 104, a skirtboard liner assembly 106 including a liner body 108, a clamp 112, a cradle 114, a frame 116, and a skirt 118. The conveyor surface 102 moves in the conveyor longitudinal direction, i.e., along the +/- Z axis of the coordinate axes depicted in the drawings. The skirtboard 104 is disposed on top of the conveyor surface 102. The skirtboard 104 may be installed on the conveyor system 100 to assist with guiding the contents 110 along the conveyor surface 102. As shown in FIG. 1, the contents 110 accumulate along the liner body 108 of the skirtboard liner assembly 106.

As noted above, the conveyor system 100 includes the clamp 112, which is mounted to the skirtboard 104 and holds the skirt 118. While the skirt 118 is adjacent to the conveyor surface 102, the skirtboard liner assembly 106, in some embodiments, may be positioned slightly above the conveyor surface 102. The skirt 118 may be formed of rubber, urethane, or any other suitable material. In a load zone, as shown, the conveyor surface 102 is supported by the cradle 114, which is in turn supported by the frame 116. However, it should be appreciated that behind the load zone illustrated in FIG. 1, the conveyor surface 102 is supported by idlers. The frame 116 is disposed and held in a stable position. In operation, the cradle 114 absorbs an impact of contents 110 falling onto the conveyor surface 102, prolonging a useful life of the conveyor surface 102. The cradle 114 also minimizes distortion to a shape of the conveyor surface 102.

Referring still to FIG. 1, and as described in more detail herein, the liner body 108 of the skirtboard liner assembly 106 extends along the skirtboard 104 and is fixed thereto in any suitable manner. The skirtboard liner assembly 106 is positioned adjacent to the conveyor surface 102 so that the contents 110 remain contained within the conveyor system 100. In embodiments, the skirtboard liner assembly 106 interfaces with the conveyor surface 102 such that the contents 110 are prevented from passing between the skirtboard liner assembly 106 and the conveyor surface 102.

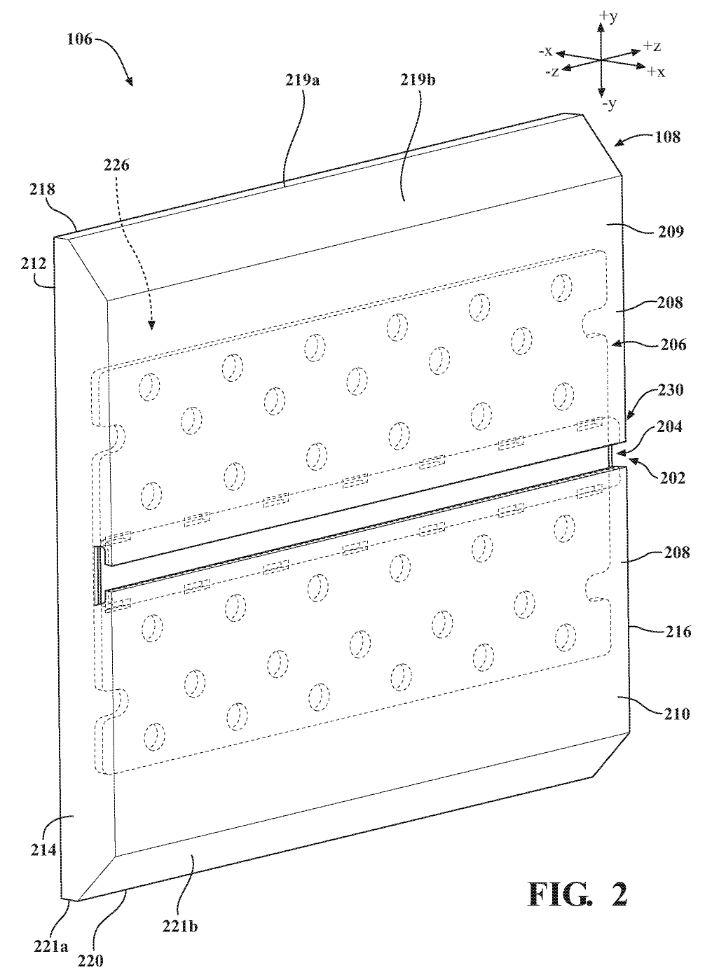

Referring now to FIG. 2, a perspective view of the skirtboard liner assembly 106 is illustrated according to one or more embodiments described herein. Specifically, an inner plate 226 is positioned within the liner body 108. The liner body 108 includes a contact surface 212, an attachment surface 208 opposite the contact surface 212, a first side surface 214 extending between the contact surface 212 and the attachment surface 208, a second side surface 216 opposite the first side surface 214 and extending between the contact surface 212 and the attachment surface 208, an upper surface 218 extending between the contact surface 212 and the attachment surface 208, and a lower surface 220 opposite the upper surface 218 and extending between the contact surface 212 and the attachment surface 208.

The attachment surface 208 includes an upper attachment surface portion 209 and a lower attachment surface portion 210. In embodiments, the upper surface 218 includes an upper planar surface portion 219a extending from the contact surface 212 and an upper angled surface portion 219b extending from the upper planar surface portion 219a to the upper attachment surface portion 209. Similarly, in embodiments, the lower surface 220 includes a lower planar surface portion 221a extending from the contact surface 212 and a lower angled surface portion 221b extending from the lower planar surface portion 221a to the lower attachment surface portion 210. As described in more detail herein, the inner plate 226 is positioned within a cavity 202 formed in the liner body 108 defined by at least the contact surface 212 and the attachment surface 208 of the liner body 108.

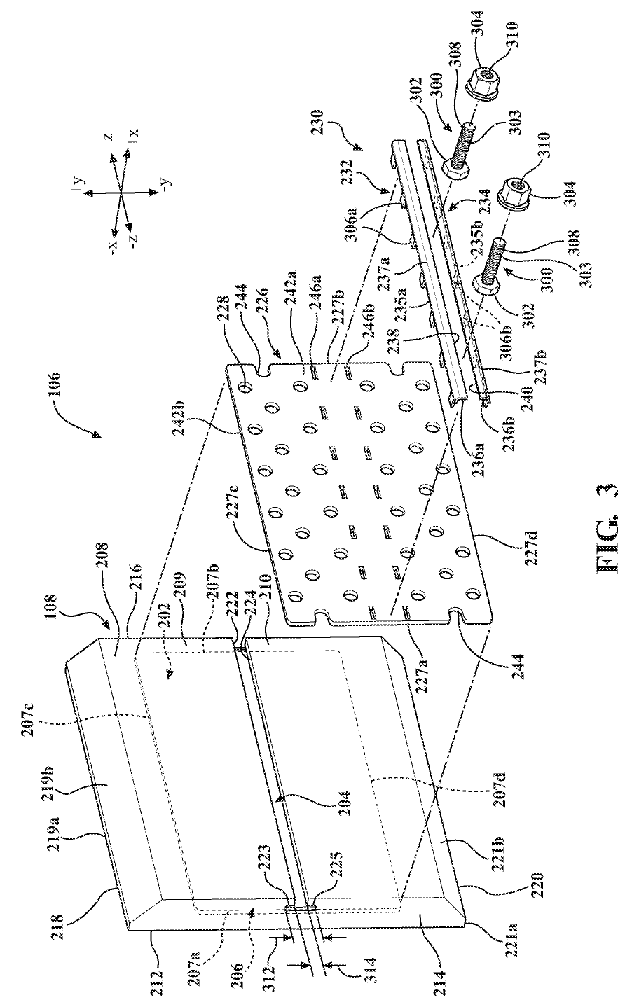

Referring now to FIG. 3, an exploded view of the skirtboard liner assembly 106 is depicted. The skirtboard liner assembly 106 includes the liner body 108, the inner plate 226, a protrusion 230, and one or more fasteners 300 for securing the liner body 108 to the skirtboard 104 (FIG. 1).

With respect to the liner body 108, the liner body 108 includes the contact surface 212, the attachment surface 208 opposite the contact surface 212, the first side surface 214, the second side surface 216, the upper surface 218, and the lower surface 220. Additionally, as noted above, the attachment surface 208 includes the upper attachment surface portion 209 and the lower attachment surface portion 210. In embodiments, the upper surface 218 includes the upper planar surface portion 219a and the upper angled surface portion 219b. Similarly, in embodiments, the lower surface 220 includes the lower planar surface portion 221a and the lower angled surface portion 221b. In operation, the lower attachment surface portion 210 is positioned proximate the conveyor surface 102 (FIG. 1), the contact surface 212 is positioned to face the contents 110 (FIG. 1), and the attachment surface 208 is positioned to face the skirtboard 104 (FIG. 1).

In embodiments, as shown in FIG. 3, the upper angled surface portion 219b of the upper surface 218 slopes in a direction towards the lower angled surface portion 221b of the lower surface 220. Stated another way, a width of the first side surface 214 and the second side surface 216 proximate the upper planar surface portion 219a of the upper surface 218 is less than a width of the first side surface 214 and the second side surface 216 proximate the upper attachment surface portion 209. Similarly, a width of the first side surface 214 and the second side surface 216 proximate the lower planar surface portion 221a of the lower surface 220 is less than a width of the first side surface 214 and the second side surface 216 proximate the lower attachment surface portion 210. In other embodiments, the upper angled surface portion 219b of the upper surface 218 and the lower angled surface portion 221b of the lower surface 220 may slope in an opposite direction of one another.

The cavity 202 of the liner body 108 is defined within an interior of the liner body 108 and, as described herein, the inner plate 226 is provided within the cavity 202. The cavity 202 defines a plate slot 206 and a T-slot 204 extending from the plate slot 206.

The plate slot 206 is defined by a plate slot first side surface 207a, a plate slot second side surface 207b opposite the plate slot first side surface 207a, a plate slot upper end surface 207c extending between the plate slot first side surface 207a and the plate slot second side surface 207b, and a plate slot lower end surface 207d opposite the plate slot upper end surface 207c and extending between the plate slot first side surface 207a and the plate slot second side surface 207b. The plate slot 206 extends in the conveyor longitudinal direction in a space between the first side surface 214 and the second side surface 216, but does not extend through the first side surface 214 or the second side surface 216. Similarly, the plate slot 206 extends in the conveyor lateral direction between the T-slot 204 and the space between the T-slot 204 and the contact surface 212, but does not extend through the contact surface 212.

The T-slot 204 defines an increased width portion 312 extending from the plate slot 206 and a reduced width portion 314 extending from the increased width portion 312 to the attachment surface 208 of the liner body 108. The T-slot 204 extends in the conveyor vertical direction at the reduced width portion 314 between an upper neck surface 222 and a lower neck surface 224.

The increased width portion 312 of the T-slot 204 is defined by an upper head surface 223 and a lower head surface 225 opposite the upper head surface 223. The upper head surface 223 and the lower head surface 225 each extend from the plate slot 206. As shown, the upper head surface 223 and the lower head surface 225 each extend toward the attachment surface 208 and curve toward one another.

As described herein, the decreased width portion of the T-slot 204 is defined by the upper neck surface 222 and the lower neck surface 224 opposite the upper neck surface 222. The upper neck surface 222 extends from the upper head surface 223, and the lower neck surface 224 extends from the lower head surface 225. As shown, the upper neck surface 222 and the lower neck surface 224 each extend toward the attachment surface 208 and are parallel to one another.

The T-slot 204 extends in the conveyor longitudinal direction between the first side surface 214 and the second side surface 216 of the liner body 108. The upper attachment surface portion 209 and the lower attachment surface portion 210 are separated by the T-slot 204 of the cavity 202. The T-slot 204 also extends in the conveyor lateral direction from the space between the upper attachment surface portion 209 and the lower attachment surface portion 210 to the plate slot 206.

As noted herein, the plate slot 206 of the cavity 202 is configured to house the inner plate 226. Referring still to FIG. 3, the inner plate 226 includes an inner plate attachment surface 242a, an inner plate contact surface 242b opposite the inner plate attachment surface 242a, an inner plate first side surface 227a, and an inner plate second side surface 227b opposite the inner plate first side surface 227a. The inner plate 226 also includes an inner plate upper end surface 227c and an inner plate lower end surface 227d opposite the inner plate upper end surface 227c. The inner plate upper end surface 227c and the inner plate lower end surface 227d extend between the inner plate first side surface 227a and the inner plate second side surface 227b.

In embodiments, one or more inner plate indents 244 are formed in the inner plate first side surface 227a. As shown, a pair of inner plate indents 244 are formed in the inner plate first side surface 227a with one of the inner plate indents 244 formed proximate the inner plate upper end surface 227c and the other of the inner plate indents 244 formed proximate the inner plate lower end surface 227d. However, it should be appreciated that any number of inner plate indents 244 may be formed in the inner plate first side surface 227a. Additionally, as shown, another pair of inner plate indents 244 are formed in the inner plate second side surface 227b with one of the inner plate indents 244 formed proximate the inner plate upper end surface 227c and the other of the inner plate indents 244 formed proximate the inner plate lower end surface 227d. However, it should be appreciated that any number of inner plate indents 244 may be formed in the inner plate second side surface 227b. Additionally, although not depicted herein, one or more inner plate indents 244 may further be formed in the inner plate upper end surface 227c and the inner plate lower end surface 227d as well.

Referring still to FIG. 3, one or more apertures 228 are formed in the inner plate 226. As shown, a plurality of apertures 228 are formed in the inner plate 226 extending between the inner plate attachment surface 242a and the inner plate contact surface 242b. The plurality of apertures 228 may include a first subset of apertures 228 formed proximate the inner plate upper end surface 227c, and a second subset of apertures 228 formed proximate the inner plate lower end surface 227d. However, it should be appreciated that the apertures 228 may be formed in any arrangement such as, for example, in rows, columns, staggered, and the like.

Referring still to FIG. 3, one or more upper finger apertures 246a and one or more lower finger apertures 246b are formed in the inner plate 226. As shown, a plurality of upper finger apertures 246a and a plurality of lower finger apertures 246b are formed in the inner plate 226 extending between the inner plate attachment surface 242a and the inner plate contact surface 242b. As shown, the plurality of upper finger apertures 246a are equidistantly spaced apart from one another. Similarly, the plurality of lower finger apertures 246b are equidistantly spaced apart from one another. However, it should be appreciated that the upper finger apertures 246a and the lower finger apertures 246b may be formed in any arrangement. The finger apertures 246a, 246b are equidistant along the upper protrusion portion 232 and the figure apertures 246 are equidistant along the lower protrusion portion 234.

When the inner plate 226 is positioned within the plate slot 206, the upper finger apertures 246a are positioned above the upper neck surface 222 in the +Y direction, and the lower finger apertures 246b are positioned below the lower neck surface 224 in the –Y direction. When the inner plate 226 is positioned within the plate slot 206, the plate slot first side surface 207a, the plate slot second side surface 207b, the plate slot upper end surface 207c, and the plate slot lower end surface 207d are adjacent the inner plate first side surface 227a, the inner plate second side surface 227b, the inner plate upper end surface 227c, and the inner plate lower end surface 227d, respectively.

Referring still to FIG. 3, a protrusion 230 is shown. In embodiments, the protrusion 230 includes an upper protrusion portion 232 and a lower protrusion portion 234 separate from the upper protrusion portion 232. However, it should be appreciated that, in embodiments, the protrusion 230 may include only the upper protrusion portion 232 or the lower protrusion portion 234. Additionally, it should be appreciated that the protrusion 230 may include additional protrusion portions not depicted herein such as, for example, the upper protrusion portion 232 and the lower protrusion portion 234 each including multiple individual portions.

The upper protrusion portion 232 includes an upper undercut protrusion surface 236a, an upper outer protrusion surface 237a, an upper finger wall 235a, and an upper neck wall 238. Similarly, the lower protrusion portion 234 includes a lower undercut protrusion surfaces 236b, a lower outer protrusion surface 237b, a lower finger wall 235b, and a lower neck wall 240. Thus, the upper protrusion portion 232 and the lower protrusion portion 234 are shaped to each curve toward one another. The upper neck wall 238 and the lower neck wall 240 are parallel to one another.

The upper protrusion portion 232 and the lower protrusion portion 234 each curve toward one another defining the undercut protrusion surfaces 236a, 236b, the outer protrusion surfaces 237a, 237b, the upper neck wall 238, and the lower neck wall 240. The upper neck wall 238 extends in the conveyor lateral direction between the upper undercut protrusion surface 236a of the upper protrusion portion 232 and the upper outer protrusion surface 237a of the upper protrusion portion 232. The lower neck wall 240 extends in the conveyor lateral direction between the lower undercut protrusion surface 236b of the lower protrusion portion 234 and the lower outer protrusion surface 237b of the lower protrusion portion 234.

The upper protrusion portion 232 includes a plurality of upper fingers 306a extending from the upper finger wall 235a. Similarly, the lower protrusion portion 234 includes a plurality of lower fingers 306b extending from the lower finger wall 235b. As described in more detail herein, the fingers 306a, 306b are received within the finger apertures 246a, 246b formed in the inner plate 226. Accordingly, the fingers 306a, 306b are positioned to correspond to a location of the finger apertures 246a, 246b respectively. The fingers 306a, 306b do not extend beyond the finger apertures 246a, 246b.

The protrusion 230 is fixed to the inner plate attachment surface 242a of the inner plate 226 and positioned within the T-slot 204 of the cavity 202 formed in the liner body 108. Specifically, the protrusion 230 extends in the conveyor longitudinal direction in the space between the first side surface 214 and the second side surface 216 of the liner body 108, but does not extend through the first side surface 214 or the second side surface 216.

With the upper protrusion portion 232 and the lower protrusion portion 234 positioned within the T-slot 204 of the cavity 202 of the liner body 108, the upper protrusion portion 232 is received within an upper portion of the T-slot 204, and the lower protrusion portion 234 is received within a lower portion of the T-slot 204. The undercut protrusion surfaces 236a, 236b are adjacent to open space of the T-slot 204 of the cavity 202 while the outer protrusion surfaces 237a, 237b are adjacent to the liner body 108. The upper neck wall 238 is also adjacent and parallel to the upper neck surface 222. Similarly, the lower neck wall 240 is also adjacent and parallel to the lower neck surface 224.

Referring still to FIG. 3, a pair of fasteners 300 are depicted as bolts. However, it should be appreciated that the fasteners 300 may be any suitable fastening member such as a screw, rivet, or the like. The fasteners 300 each include a head 302 and a shaft 303 extending from the head 302. The shaft 303 of the fasteners 300 includes fastener threads 308.

The width of the head 302 is greater than the diameter of the shaft 303. Additionally, the width of the head 302 is less than the greatest height of the T-slot 204. The diameter of the shaft 303 is less than the distance between the upper neck surface 222 and the lower neck surface 224 and likewise less than the distance between the upper neck wall 238 and the lower neck wall 240. Therefore, the shape and size of the T-slot 204 leaves the ability of the fastener 300 to slide freely through the entire skirtboard liner assembly 106, as described in more detail herein.

As described herein, the width of the head 302 of the fastener 300 is less than a distance between the undercut protrusion surfaces 236a, 236b when the upper protrusion portion 232 and the lower protrusion portion 234 are positioned within the liner body 108. This permits the head 302 to be inserted between the upper protrusion portion 232 and the lower protrusion portion 234. However, as described herein, the width of the head 302 of the fastener 300 is greater than a distance between the upper neck surface 222 and the lower neck surface 224. This prevents the fastener 300 from being disengaged with the inner plate 226 when the upper protrusion portion 232 and the lower protrusion portion 234 are positioned within the liner body 108. Additionally, as described herein, the diameter of the shaft 303 is less than the distance between the upper neck surface 222 and the lower neck surface 224 and likewise shorter than the distance between the upper neck wall 238 and the lower neck wall 240. Therefore, the shape and size of the T-slot 204 permits the fastener 300 to slide freely through the entire skirtboard liner assembly 106.

Additionally, a pair of locknuts 304 are depicted as engaging the shaft 303 of a respective fasteners 300. The locknuts 304 include locknut threads 310 for engaging the fastener threads 308 of a respective fastener 300. The shaft 303 is threaded by the fastener threads 308 to be screwed onto the locknut thread 310. As used herein, the locknut 304 can include any suitable nut, for example, washer and nut, flange nut, square nut, hex nut, wing nut, and the like.

Although it is described herein that the inner plate 226 is inserted into the plate slot 206 and the protrusion 230 is inserted into the T-slot 204, it should be appreciated that, in other embodiments, the liner body 108 is formed around the inner plate 226 and the protrusion 230. More specifically, the liner body 108 may be molded around the inner plate 226 and the protrusion 230.

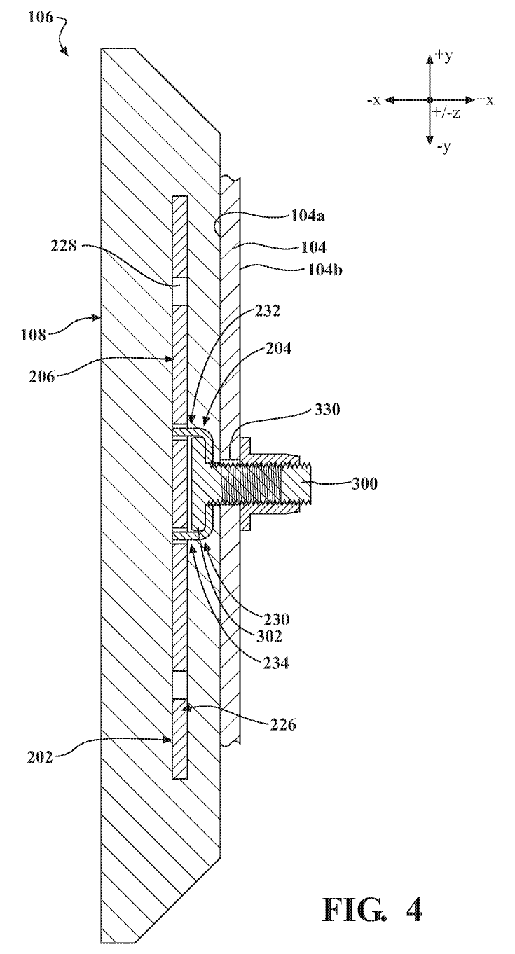

Referring now to FIG. 4, a cross-sectional side view of the skirtboard liner assembly 106 is shown mounted onto the skirtboard 104. As shown, the inner plate 226 is received within the plate slot 206, and the protrusion 230 is received within the T-slot 204. Additionally, the head 302 of the fastener 300 is shown received within the T-slot 204 between the upper protrusion portion 232 and the lower protrusion portion 234.

The upper fingers 306a and lower fingers 306b are shown extending into upper finger apertures 246a and the lower finger apertures 246b, respectively. In embodiments, the upper protrusion portion 232 and the lower protrusion portion 234 may be fixed, such as by welding or the like, to the inner plate 226 to secure the protrusion 230 to the inner plate 226.

The inner plate 226 may provide a rigid support for the protrusion 230. The fastener 300 may be tightened into a proper position to allow the skirtboard liner assembly 106 to be slid into a desired place against the skirtboard 104. Horizontal adjustment of the skirtboard liner assembly 106 may be allowed along the fastener 300 as the skirtboard liner assembly 106 is movable, independent of the fastener 300. Although not illustrated herein, it should be appreciated that the skirtboard liner assembly 106 may be also adjusted in a vertical direction by including additional slots formed in the skirtboard 104 to permit vertical positioning of the skirtboard liner assembly 106 relative to the skirtboard 104.

In operation, the fastener 300 is positioned to extend through a hole 330 formed in a skirtboard 104 (FIG. 1) from a first side 104A of the skirtboard 104 and the locknut 304 is secured to the fastener 300 at an opposite second side 104B of the skirtboard 104. Thereafter, with the inner plate 226 received within the plate slot 206 of the cavity 202 and the protrusion 230 received within the T-slot 204 of the cavity 202, the liner body 108 is translated along the skirtboard 104 such that the head 302 of the fastener 300 is received within the T-slot 204. The locknut 304 may then be further engaged with the fastener 300 to secure the liner body 108 against the skirtboard 104.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A skirtboard liner assembly for a conveyor system, comprising:
a liner body defining a cavity including a plate slot and a T-slot extending from the plate slot;
an inner plate positioned within the plate slot of the cavity formed in the liner body; and
a protrusion fixed to an attachment surface of the inner plate and positioned within the T-slot of the cavity formed in the liner body, the protrusion including an upper protrusion portion and a lower protrusion portion.

2. The skirtboard liner assembly of claim 1, further comprising a fastener including a head and a shaft, the head of the fastener positionable within the T-slot of the cavity.

3. The skirtboard liner assembly of claim 1, wherein the liner body includes a first side surface and a second side surface opposite the first side surface.

4. The skirtboard liner assembly of claim 3, wherein the T-slot of the cavity extends between the first side surface and the second side surface of the liner body.

5. The skirtboard liner assembly of claim 3, wherein the liner body includes an upper surface and a lower surface opposite the upper surface, the upper surface and the lower surface extending between the first side surface and the second side surface.

6. The skirtboard liner assembly of claim 5, wherein the upper surface and the lower surface each taper in a direction opposite one another.

7. The skirtboard liner assembly of claim 1, wherein a plurality of apertures are formed in the inner plate, spaced equidistantly spaced apart from one another both above and below the T-slot of the cavity.

8. The skirtboard liner assembly of claim 7, wherein the protrusions comprises a plurality of fingers.

9. The skirtboard liner assembly of claim 8, wherein the plurality of fingers are provided on the upper protrusion portion and the lower protrusion portion.

10. The skirtboard liner assembly of claim 9, wherein the plurality of fingers of the one or more protrusions are received within finger apertures formed in the inner plate.

11. The skirtboard liner assembly of claim 1, wherein the upper protrusion portion and the lower protrusion portion are separately attached to the inner plate.

12. The skirtboard liner assembly of claim 1, wherein the upper protrusion portion and the lower protrusion portion each curve toward one another.

13. A conveyor system, comprising:
a conveyor surface;
a skirtboard provided on opposite sides of the conveyor surface; and
a skirtboard liner assembly including:
a liner body fixed to the skirtboard, the liner body defining a cavity including a plate slot and a T-slot extending from the plate slot;
an inner plate positioned within the plate slot of the cavity formed in the liner body;
one or more protrusions fixed to an attachment surface of the inner plate and positioned within the T-slot of the cavity formed in the liner body, the one or more protrusions defining an upper protrusion portion and a lower protrusion portion; and
one or more fasteners fixed into the skirtboard, the one or more fasteners including a head and a shaft, the head of the fastener positionable within the T-slot of the cavity.

14. The conveyor system of claim 13, wherein the liner body includes a first side surface and a second side surface opposite the first side surface.

15. The conveyor system of claim 14, wherein the T-slot of the cavity extends between the first side surface and the second side surface of the liner body.

16. The conveyor system of claim 14, wherein the liner body includes an upper surface and a lower surface opposite the upper surface, the upper surface and the lower surface extending between the first side surface and the second side surface.

17. The conveyor system of claim 16, wherein the upper surface and the lower surface each taper in a direction opposite one another.

18. The conveyor system of claim 13, wherein the skirtboard liner assembly is movable along the fastener in a horizontal direction with respect to a conveyor belt of the conveyor system.

19. The conveyor system of claim 13, further comprising a contact surface of the liner body configured to guide contents moving on a conveyor belt.

20. A method comprising:
extending a shaft of a fastener through an opening formed in a skirtboard at an inner surface of the skirtboard, the fastener including a head provided at an end of the shaft;
attaching a locknut onto the shaft of the fastener at an outer surface of the skirtboard;
sliding a liner body relative to the skirtboard such that the head of the fastener is received within a T-slot of a cavity formed in the liner body; and
engaging the locknut with the fastener to secure the liner body to the skirtboard.
